(19) United States
(12) Patent Application Publication
(10) Pub. No.: US 2010/0260902 A1
(43) Pub. Date: Oct. 14, 2010

(54) High Fiber Nutritional Emulsions

(76) Inventors: Joseph E. Walton, Westerville, OH (US); David R. Wolf, Worthington, OH (US); Neile K. Edens, Columbus, OH (US); Vikkie A. Mustad, Galena, OH (US)

Correspondence Address: ROSS PRODUCTS DIVISION OF ABBOTT LABORATORIES;DEPARTMENT 108140-DS/1, 625 CLEVELAND AVENUE, COLUMBUS, OH, 43215-1724, US

(21) Appl. No.: 12/758,577

(22) Filed: Apr. 12, 2010

Related U.S. Application Data
(60) Provisional application No. 61/168,430, filed on Apr. 10, 2009.
(60) Provisional application No. 61/169,022, filed on Apr. 14, 2009.

(51) Int. Cl. A23D 7/005; A23L 1/308; B65D 85/72

(52) U.S. Cl. 426/124; 426/602; 426/648

(57) ABSTRACT

Disclosed are nutritional aqueous emulsions having high fiber content. These emulsions comprise fat, protein, and carbohydrate, which includes from 1.75% to about 4.0% by weight of diacylglycerol oil and from about 1.5% to about 9.0% by weight of fiber. These emulsions may also comprise fat, protein, and carbohydrate, which includes from 1% to about 4.0% of diacylglycerol oil by weight of the aqueous emulsion and from about 2.0% to about 9.0% of fiber by weight of the aqueous emulsion, wherein the aqueous emulsion has a viscosity of less than about 300 centipoise at 20° C. These high fiber emulsions provide beneficial features, including one or more of stability, desirable hedonics, rheology, and product performance, including a blunted glycemic response profile and or minimal or no gastrointestinal intolerance.

This application makes reference to and claims priority back to U.S. Provisional Application 61/168,430 filed Apr. 10, 2009 and U.S. Provisional Application 61/169,022 filed Apr. 14, 2009.

### FIELD OF THE INVENTION

The present invention relates to nutritional emulsions having a low viscosity and high fiber concentrations.

### BACKGROUND OF THE INVENTION

There are many different types of milk or protein-based emulsions suitable for oral administration to humans as a sole or supplemental nutrition source. These emulsions are typically manufactured as oil-in-water emulsions comprising fat, protein, carbohydrate, vitamins, and minerals. Examples of such emulsions include ENSURE® Nutritional Liquid and GLUCERNA® Shake available from Abbott Laboratories, Columbus, Ohio USA.

Many of these nutritional emulsions are manufactured with added fiber to provide any of a number of benefits. Proper intake of fiber is believed to reduce the risk of developing various conditions such as heart disease, diabetes, diverticular disease, and constipation. Fiber is often formulated into nutritional emulsions to help reduce the glycemic index of a carbohydrate-containing emulsion, which may be of benefit to many individuals, including diabetics as well as individuals interested in the many benefits associated with a more modulated glycemic response.

Given the many benefits of a high fiber diet, it is often recommended that children and adults consume at least 20 grams of dietary fiber per day. In fact, the more calories an individual consumes each day, the more fiber he or she needs for a healthy diet. Teens and men, for example, may require 30-35 grams of fiber per day or more, depending upon their specific dietary intake.

Notwithstanding the need for relatively high fiber content in most diets, the average American consumes only about 15 grams of fiber per day, despite the fortification of many foods with added fiber. There is therefore a need for nutritional products, such as protein or milk-based emulsions that are manufactured with relatively high fiber concentrations to better meet the nutritional needs of the typical consumer.

The formulation of nutritional emulsions, however, with higher fiber concentrations often creates a number of issues, some of which are unique to emulsion-based matrices. High fiber content can impair emulsion stability, necessitate the need for harsh processing temperatures, reduce gastrointestinal tolerance, and create undesirable hedonics such as poor mouth feel, grittiness, flavor changes, and so forth.

There is a need, therefore, for nutritional emulsions that contain higher fiber concentrations but also have relatively low and therefore drinkable viscosities, but without some or all of the negatives historically associated with high fiber emulsions.

### SUMMARY OF THE INVENTION

A first embodiment of the high fiber nutritional emulsions comprises fat, protein, and carbohydrate, and includes from 1.75% to about 4.0% by weight of diacylglycerol oil and from about 1.5% to about 9.0% by weight of fiber, wherein the emulsion has a viscosity of less than about 300 cps.

A second embodiment of the high fiber nutritional emulsions comprise fat, protein, and carbohydrate, and include 1% to about 4.0% of diacylglycerol oil by weight of the aqueous emulsion and from about 2.0% to about 9.0% of fiber by weight of the aqueous emulsion, wherein the emulsion has a viscosity of less than about 300 cps.

A third embodiment of the high fiber nutritional emulsions comprise fat, protein, and carbohydrate, and include 1% to about 4.0% of diacylglycerol oil by weight of the aqueous emulsion and from about 2.0% to about 9.0% of fiber by weight of the aqueous emulsion, wherein the nutritional emulsion is contained within a package having a majority inner plastic surface in contact with the nutritional emulsion, wherein the emulsion has a viscosity of less than about 300 cps.

A fourth embodiment of the high fiber nutritional emulsions comprise fat, protein, and carbohydrate, and include 1.75% to about 4.0% of diacylglycerol oil by weight of the aqueous emulsion and from about 1.5% to about 9.0% of fiber by weight of the aqueous emulsion, wherein the emulsion has a viscosity of less than about 300 cps and is contained within a package having a majority inner plastic surface in contact with the nutritional emulsion.

These nutritional compositions are aqueous oil-in-water emulsions that, despite the high fiber content, have desirable physical and chemical stability under varied conditions, and desirable hedonics, rheologies, and product performance, including a blunted glycemic response profile and or minimal or no gastrointestinal intolerance. The emulsions are especially useful when contained within a package having a majority interior surface in contact with the nutritional emulsion that is plastic rather than metal, glass, or other non-plastic surface.

### BRIEF DESCRIPTION OF THE DRAWINGS

FIG. 1 is a graph from Study 1 illustrating fasting plasma insulin concentrations (mmole/L) at 0, 14 and 28 days in Zucker fa/fa rats fed diets supplemented with A1, A2 and A3 formulations.

FIG. 2 is a graph from Study I illustrating differences in insulin sensitivity as determined by an insulin tolerance test (changes in blood glucose at defined times post gavage) for Zucker fa/fa rats supplemented with A1, A2 and A3 formulations.

FIG. 3 is a graph from Study I illustrating glycated hemoglobin (%) at 0 and 28 days in Zucker fa/fa rats fed diets supplemented with A1, A2 or A3 formulations. The change in glycated hemoglobin from day 0 to day 28 is indicated by the upper section of each charted bar.

FIG. 4 is a graph from Study II illustrating fasting plasma insulin concentrations (p mol/L) at 0, 14 and 28 days in Zucker fa/fa rats fed a Study Diet or the Study Diet voluntarily supplemented with the A1 formulation. The graph shows that voluntary consumption of the A1 formulation attenuated the increase in plasma insulin seen in the control group (*: p<0.05).

FIG. 5 is a graph from Study II illustrating blood glucose (mg/dl) levels at 0, 30, 60, 90, and 120 minutes post insulin injection in Zucker fa/fa rats fed either a Study Diet or the Study Diet voluntarily supplemented with the A1 formulation (p<0.05).

FIG. 6 is a graph from Study II illustrating glycated hemoglobin (%) in Zucker fa/fa rats at day 0 and 28 of the study in which the rats are fed either a Study Diet or the Study Diet voluntarily supplemented with the A1 formulation. The upper section of the bar is the change in glycated hemoglobin from day 0 to day 28 of the study. Voluntary consumption of the A1 formulation attenuated the increase in glycated hemoglobin seen in the unsupplemented group.

FIG. 7 is a graph from Study III that shows the total food intake (kcals) by Zucker fa/fa rats fed either a control chow or a semi-purified diet (Study Diet) suggesting a preference for the more palatable Study Diet.

FIG. 8 is a graph from Study III that shows cumulative food intake (kcal) by Zucker fa/fa rats fed a Study Diet alone or the Study Diet supplemented with the A1 formulation. The graphs shows that the animals rats chose to decrease consumption of the palatable, preferred study diet to compensate for the calories they consumed as A1 formulation (p<0.05).

### DETAILED DESCRIPTION OF THE DISCLOSURE

The high fiber nutritional emulsions may comprise various combinations of diacylglycerol oil, fiber, fructose and leucrose, milk protein concentrate, and glycerin, as well as other optional or other components. The essential features of the nutritional emulsions, as well as some of the many optional variations, are described in detail hereafter.

The term “nutritional emulsion” as used herein, unless otherwise specified, means an aqueous emulsion suitable for oral administration to a human and comprising fat, protein, carbohydrates.

The terms “fat” and “oil” as used herein, unless otherwise specified, are used interchangeably to refer to lipid materials derived or processed from plants or animals.

The term “high fiber” as used herein, unless otherwise specified, means a fiber concentration of from about 1.5% to about 9%, more typically from about 2.0% to about 9%, by weight of a nutritional emulsion.

The term “hedonics” as used herein, unless otherwise specified, may refer to one or more of the following properties of the nutritional emulsions: aroma, mouth feel, texture, taste, and color or physical appearance.

The term “rheologies” as used herein, may refer to the desirable viscoelastic properties of the nutritional emulsion, including those under varied conditions such as increased or decreased storage temperatures, to reflect, among other features, the enhanced emulsion and or suspension stability of the nutritional emulsions.

The term “product performance” as used herein, unless otherwise specified, may refer to the desirable benefits of the packaged nutritional emulsions described herein, wherein such benefits include one or more of increased gastrointestinal tolerance, desirably blunted glycemic response at varied times and under specified circumstances, increased insulin sensitivity, blunted glycemic response to a meal, and desirable product package interactions.

All viscosity values as referenced herein, unless otherwise specified, are obtained using a Brookfield Viscometer (Model DV-II+) with a 62 spindle at room temperature (20° C.), or at the temperature so designated. The viscosity is measured by operating the viscometer at a spindle speed that is the highest speed possible to obtain a reading that is on scale. The measured viscosity values represent the ratio of shear stress to shear rate, expressed as dynes-second/cm2, or poise, or more typically as centipoise (cps) or one hundredth of a poise.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified.

As used herein, any reference to a singular characteristic or feature shall include the corresponding plural characteristic or feature, and vice versa, unless otherwise specified.

Any combination of method or process steps as used herein may be performed in any order, unless otherwise specified.

The various embodiments of the nutritional emulsions may be substantially free of any specific ingredient described herein, provided that the remaining nutritional emulsion comprises all of the essential limitations described herein. In this context, the term “substantially free” means the compositions comprise less than a functional amount of the identified ingredient disclosed herein, typically less than about 1.0%, including less than about 0.5%, also including less than about 0.1%, and also including zero percent, by weight of the identified ingredient.

The various embodiments of the nutritional emulsions may comprise, consist of, or consist essentially of any of the essential features or ingredients described herein, as well as any additional or optional features or ingredients described herein or otherwise useful in a nutritional emulsion.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

### Product Form

The nutritional emulsions are aqueous systems in the form of oil-in-water, water-in-oil, or complex emulsions, although most typically the emulsions are oil-in-water emulsions having a continuous aqueous phase and a discontinuous oil phase. Water content varies among the emulsions but most typically ranges from about 70% to about 90%, more typically from about 75% to about 85%, by weight of the emulsions.

The nutritional emulsion have a drinkable viscosity at room temperature and or when chilled prior to consumption. The emulsions may therefore have a viscosity as measured at room temperature (20° C.) of less than about 300 cps, typically from about 10 cps to about 160 cps, and more typically from about 20 cps to about 70 cps.

The nutritional emulsions may be formulated with sufficient kinds and amounts of nutrients to provide a sole, primary, or supplemental source of nutrition, or to provide a specialized nutritional emulsion for use in individuals afflicted with specific diseases or conditions such as, for example, diabetes or other abnormal glucose tolerance conditions.

These nutritional emulsions may also have a product density of greater than about 1.055 g/mL, including from 1.06 g/ml to 1.08 g/ml.

The nutritional emulsions may be retort or aseptically packaged in a suitable glass, plastic, metal, or other container, although it has been found advantageous to formulate with a plastic or other non-metal and non-glass container or package having a plastic interior surface in contact with the emulsions, which plastic interior surface represents a majority of the interior surface area of the container or package. These packages are particularly useful when used with the emulsions and subjected to retort sterilization and packaging.

### Diacylglycerol

The nutritional emulsions may comprise a diacylglycerol oil as defined herein. Such diacylglycerol oil concentrations range from at least about 1%, including from about 1.75% to about 4%, and also including from about 1.8% to about 3%, and also including from about 1.9% to about 2.7%, by weight of the emulsion.

The term “diacylglycerol oil” is an art recognized term and as used herein refers to a processed oil comprising from about 60% to 100%, including from about 70% to about 85%, by weight of a diglyceride. The diacylglycerol oil may represent from about 10% to 100%, including from about 40% to about 80%, and also including from about 50% to about 70%, by weight of the fat in the emulsion

Diacylglycerol oils are well known in the nutrition arts and typically comprise a blend of monoglycerides, diglycerides, and triglycerides, wherein the diglycerides represent a majority of the glycerol esters therein. These oils are typically processed vegetable oils such as soy and or cocoa oils comprising about 80% by weight of diglycerides and about 20% by weight of other glycerol esters, i.e., triglycerides and monoglycerides. The diglycerides may comprise C16-24 fatty acid esters, including C16-20 fatty acid esters, most typically esters of oleic, linoleic and or linolenic acid. A non limiting example of a diacylglycerol oil suitable for use herein is Enova® Oil, available from Kao Health and Nutrition, Itasca, Ill., USA.

Although the nutritional emulsions may comprise any of a variety of natural oils, most or all of which comprise a minor amount of diacylglycerol esters (diglycerides), these natural oils do not contain sufficient relative amounts of diglycerides to represent the diacylglyerol oil component of the emulsions herein.

The nutritional emulsions may further comprise lecithin in combination with the diacylglycerol oil. Lecithin concentrations may range from at least about 0.1%, including from about 0.16% to about 0.5%, by weight of the emulsion.

The diacylglycerol component may be replaced and the desired physical stability of the formulations described herein maintained with an oil blend comprising from 30 to 50%, high oleic safflower oil, from 20 to 40% Canola oil, from 15 to 35% soy oil, and 1 to 10% lecithin, all by weight of the oil blend, including a blend of 40/30/25/5 of these oils, respectively. The replacement blend may be used at the same concentrations by weight of the finished nutritional emulsion described herein for the diacylglycerol component.

### Fiber

The nutrition emulsions comprise fiber at levels representing at least about 1.5%, including from about 2.0% to about 9%, and also including from about 2.1% to about 6%, and also including from about 2.2% to about 4.3%, by weight of the emulsions. The fiber may represent from about 10% to 100%, including from about 12% to about 40%, and also including from about 15% to about 25%, by weight of the total carbohydrates in the emulsions.

The fiber as used herein refers generally to those components of a nutritional product that are not absorbed by the body or not otherwise broken down by enzymes in the human digestive tract to small molecules and then absorbed. The fiber may include any known fiber or fiber source suitable for oral administration in a nutritional product, including fiber or sources thereof that are soluble and or insoluble, fermentable or non fermentable, or combinations or variations thereof.

Fiber for use herein may be divided into soluble and insoluble types based on the fiber's capacity to be solubilized in a buffer solution at a defined pH. Fiber sources differ in the amount of soluble and insoluble fiber they contain. As used herein, unless otherwise specified, soluble and insoluble fiber designations, and concentrations or amounts thereof and including total fiber concentrations are determined using Association of Official Analytical Chemists (AOAC) Method 991.43.

Non limiting examples of soluble dietary fiber or fiber sources for use herein include gum arabic, sodium carboxymethylcellulose, guar gum, citrus pectin, low and high methoxy pectin, oat and barley glucans, carrageenan and psyllium. Numerous commercial sources of soluble dietary fibers are available. For example, gum arabic, hydrolyzed carboxymethylcellulose, guar gum, pectin and the low and high methoxy pectins are available from TIC Gums, Inc. of Belcamp, Md. The oat and barley glucans are available from Mountain Lake Specialty Ingredients, Inc. of Omaha, Nebr. Psyllium is available from the Meer Corporation of North Bergen, N.J. while the carrageenan is available from FMC Corporation of Philadelphia, Pa.

Non limiting examples of insoluble dietary fiber or fiber sources for use herein include oat hull fiber, pea hull fiber, soy hull fiber, soy cotyledon fiber, sugar beet fiber, cellulose and corn bran. Numerous sources for the insoluble dietary fibers are also available. For example, the corn bran is available from Quaker Oats of Chicago, Ill.; oat hull fiber from Canadian Harvest of Cambridge, Minn.; pea hull fiber from Woodstone Foods of Winnipeg, Canada; soy hull fiber and oat hull fiber from The Fibrad Group of LaVale, Md.; soy cotyledon fiber from Protein Technologies International of St. Louis, Mo.; sugar beet fiber from Delta Fiber Foods of Minneapolis, Minn. and cellulose from the James River Corp. of Saddle Brook, N.J.

The fiber for use herein may also include fructooligosaccharides (FOS), including those having a degree of polymerization of from 2 to 10, most typically from 3-7, and or inulin, including inulin having a degree of polymerization of at least 10, including from about 20 to about 50, and or a glucooligosaccharides (GOS). The FOS, GOS, and or inulin may represent from zero to about 50%, including from about 5% to about 30%, including from about 10% to about 20%, by weight of the fiber in the nutritional emulsion. As used herein, the fiber content of FOS fiber may be determined in accordance with Association of Official Analytical Chemists (AOAC) Method 997.08 or otherwise assumed to be about 96% by weight of the FOS.

One commercial fiber source suitable for use herein is Fibersol-2™, a soluble fiber source comprising about 37% by weight of dietary fiber, which is available from ADM Company, Decatur, Ill., USA.

The nutritional emulsions may also comprise a weight ratio of the fiber to the diacylglycerol oil of at least about 1.20:1, including from about 1.23:1 to about 5:1, and also including from about 1.24:1 to about 1.8:1.

### Sugar

The nutritional emulsions may comprise relatively low sugar concentrations ranging from zero to about 2.1%, including from about 0.5% to about 1.8%, and also including from about 0.9% to about 1.7%, by weight of the emulsion. As such, the emulsions may also have a high fiber to sugar ratio of greater than about 1:1, including from about 20:1 to about 1:1, and also including from about 3:1 to about 1.4:1.

In the present context, the term “sugar” refers to the total sum of mono and disaccharides in the emulsions.

The total carbohydrate to sugar ratio in the nutritional emulsions may range from at least about 5:1, including from about 5.5:1 to about 20:1, including from about 6:1 to about 10:1, and also including from about 7:1 to about 9:1.

The nutritional emulsions may further comprise artificial sweeteners such as saccharin, aspartame, sucralose, neotame, acesulfame potassium, or combinations thereof. The ratio of the artificial sweeteners to sugar may range from at least about 0.0060:1, including from about 0.0070:1 to about 0.0300:1, including from about 0.0080:1 to about 0.0095:1.

The nutritional emulsions may also comprise glycerin as a sweetening agent, which may be used in combination with sugar (at low sugar concentrations described herein) and the artificial sweeteners in the artificial sweetener to sugar ratios as described herein.

### Milk Protein Concentrate

The nutritional emulsions may comprise milk protein concentrate (MPC), which may represent some or all of the protein in the emulsions. The emulsions may comprise MPC at concentrations of at least about 0.5%, including from about 1% to about 9%, and also including from about 2% to about 6%, by weight of the emulsions.

Suitable milk protein concentrates for use herein include any such concentrate that is suitable for use in an oral nutritional product. In this context, the term “milk protein concentrate” refers to bovine milk products having a protein content that typically represents from about 40% to about 88%, including from about 60% to about 80%, and also including from about 65% to about 75%, by weight of the milk product. Milk protein concentrates also typically comprise minor amounts of lactose and milk fat.

### Glycerin

The nutritional emulsions may comprise glycerin, concentrations of which may represent from about 2.0% to about 6.0%, including from about 2.1% to about 4.0%, and also including from about 2.2% to about 3.0%, by weight of the nutritional emulsion.

Suitable glycerin sources include any glycerin product suitable for use in an oral nutritional product.

### Fructose and Leucrose

The nutritional emulsions may comprise a combination of fructose and leucrose, wherein the leucrose represents at least about 0.15% by weight of the nutritional emulsion, including from about 0.15% to about 1.0%, and also including from about 0.30% to about 0.40%, by weight of the nutritional emulsion, wherein the weight ratio of fructose to leucrose is at least about 1.5:1, including from about 2:1 to about 20:1, and also including from about 2.8:1 to about 8:1.

The fructose and leucrose may be added individually or in combination to the nutritional emulsion. A commercial source of one such combination is available from Cargill Sweetener Solutions, Minneapolis, Minn., USA, as Cargill's Sucromalt SMO5 syrup which includes on a dry weight basis about 37% fructose, 13% leucrose, 48% saccharides and 2% other disaccharides.

### Chromium Picolinate

The nutritional emulsions may comprise chromium picolinate at concentrations suitable for oral administration. Such concentrations may range from at least about 0.002%, including from about 0.0020% to about 0.00010%, and also including from about 0.0010% to about 0.00040%, and also including from about 0.00090% to about 0.00060%, by weight of the emulsion.

Chromium picolinate may be formulated into the nutritional emulsions described herein to assist in blood glucose control when used in combination with the other nutrients described herein.

### Macronutrients

The nutritional emulsions comprise fat, protein, and carbohydrate. Generally, any source of fat, protein, and carbohydrate that is known or otherwise suitable for use in an oral nutritional product is also suitable for use herein, provided that such nutrients are also compatible with the other selected ingredients in the formulation.

Although total concentrations or amounts of the fat, protein, and carbohydrates may vary depending upon the nutritional needs of the intended user, such concentrations or amounts most typically fall within one of the following embodied ranges, inclusive of other essential fat, protein, and or carbohydrate ingredients as described herein.

Carbohydrate concentrations most typically range from about 5% to about 40%, including from about 7% to about 30%, including from about 10% to about 25%, by weight of the nutritional emulsion; fat concentrations most typically range from about 2% to about 30%, including from about 3% to about 15%, and also including from about 5% to about 10%, by weight of the nutritional emulsion; and protein concentrations most typically range from about 0.5% to about 30%, including from about 1% to about 15%, and also including from about 2% to about 10%, by weight of the nutritional emulsion.

Non-limiting examples of suitable fats or sources thereof for use in the nutritional emulsions described herein include diacylglycerol oil as described herein, lecithin as described herein, coconut oil, fractionated coconut oil, soy oil, corn oil, olive oil, safflower oil, high oleic safflower oil, MCT oil (medium chain triglycerides), sunflower oil, high oleic sunflower oil, palm and palm kernel oils, palm olein, canola oil, marine oils, cottonseed oils, and combinations thereof.

Non-limiting examples of suitable carbohydrates or sources thereof for use in the nutritional emulsions described herein may include maltodextrin, hydrolyzed or modified starch or cornstarch, glucose polymers, corn syrup, corn syrup solids, rice-derived carbohydrates, glucose, fructose, lactose, high fructose corn syrup, honey, sugar alcohols (e.g., maltitol, erythritol, sorbitol), and combinations thereof.

Non-limiting examples of suitable protein or sources thereof for use in the nutritional emulsions include hydrolyzed, partially hydrolyzed or non-hydrolyzed proteins or protein sources, which may be derived from any known or otherwise suitable source such as milk (e.g., casein, whey), animal (e.g., meat, fish), cereal (e.g., rice, corn), vegetable (e.g., soy) or combinations thereof. Non-limiting examples of such proteins include milk protein isolates, milk protein concentrates as described herein, casein protein isolates, whey protein, caseinates, whole cow's milk, partially or completely defatted milk, soy protein isolates, soy protein concentrates, and so forth.

### Optional Ingredients

The nutritional emulsion may further comprise other optional ingredients that may modify the physical, chemical, hedonic or processing characteristics of the products or serve as pharmaceutical or additional nutritional components when used in the targeted population. Many such optional ingredients are known or otherwise suitable for use in other nutritional products and may also be used in the nutritional emulsions described herein, provided that such optional ingredients are safe and effective for oral administration and are compatible with the essential and other ingredients in the selected product form.

Non-limiting examples of such optional ingredients include preservatives, antioxidants, emulsifying agents, buffers, pharmaceutical actives, additional nutrients as described herein, colorants, flavors, thickening agents and stabilizers (e.g., carrageenan, avicel), sterols, phytosterols, turmeric, lubricants and so forth.

The nutritional emulsions may further comprise vitamins or related nutrients, non-limiting examples of which include vitamin A, vitamin D, vitamin E, vitamin K, thiamine, riboflavin, pyridoxine, vitamin B12, carotenoids, niacin, folic acid, pantothenic acid, biotin, vitamin C, choline, inositol, salts, and derivatives thereof, and combinations thereof.

The nutritional emulsion may further comprise minerals, non-limiting examples of which include calcium, phosphorus, magnesium, iron, zinc, manganese, copper, sodium, potassium, molybdenum, chromium, selenium, chloride, and combinations thereof.

### Method of Manufacture

The nutritional emulsions may be manufactured by any conventional or otherwise known method for making nutritional emulsions, most typically for making nutritional aqueous emulsions or milk based emulsions.

In one suitable conventional manufacturing process, two or more separate slurries are prepared, one of which is an aqueous slurry that is substantially free of fat. One or more additional slurries may include a protein in a fat/oil slurry (e.g., protein, fat, emulsifier or surfactant, etc.) a protein in water slurry (e.g., protein in water), and additional carbohydrate-mineral slurries. The multiple slurries are eventually combined together in a blend tank, subjected to ultra high temperature processing, homogenized, infused with added vitamins, minerals, or other optional ingredients, and diluted with water as appropriate.

The manufacturing processes may further include packaging the resulting nutritional emulsion in a suitable container that may either be, for example, metal, glass or plastic, and may be re-closeable. The method may also further include exposing the packaged nutritional emulsion to retort sterilization to produce a retort packaged nutritional emulsion. Retort sterilization is a process step well known to one of ordinary skill in the formulation art, which typically involves high temperature treatment of a packaged liquid nutritional. The nutritional emulsion may also be aseptically packaged rather than retort sterilized.

The manufacturing processes for the nutritional emulsions are not critical and may be carried out in other ways than those set forth herein without departing from the spirit and scope of the present invention. The present embodiments are, therefore, to be considered in all respects illustrative and not restrictive and that all changes and equivalents also come within the description of the present invention.

Surprisingly, it has now been discovered the certain combinations of components as disclosed and described herein may provide unexpected benefits to the high fiber nutritional emulsions. One or more of these unexpected benefits may be the result of a synergistic combination of two or more the components described herein. One or more of the combination of specific components described herein may impart improved and unexpected characteristics to the high fiber emulsions as compared to conventional nutritional emulsions. In one embodiment, the combination of components in the high fiber emulsion may provide an improved glycemic response in combination with a higher caloric content. In another embodiment, the combination of components in the high fiber emulsion may provide a highly stable high fiber emulsion that can be manufactured using more desirable, low-temperature processing, despite the high fiber content. In yet another embodiment, the components of the high fiber emulsion may provide improved hedonics and improved gastrointestinal tolerance while providing high fiber, higher calories, and an improved blunted glycemic response.

Novel component blends utilized in the high fiber emulsions described herein may include any combination of any two, three, four, five or more of the following components, which may each individually or in combination (even synergistic combination) contribute to the surprising benefits of the high fiber emulsions described above: diacylglycerol oil, milk protein concentrate, sucromalt, fiber, fructooligosaccharides, insoluble fiber, turmeric, glycerin, chromium picolinate, monounsaturated fatty acids having from 16-24 carbon atoms, leucrose, and fructose. That is, any one of these components may be combined with any one or more of the other components and may provide surprising benefits to the resulting high fiber emulsion.

### EXAMPLES

The following examples illustrate specific embodiments and or features of the nutritional emulsions. The examples are given solely for the purpose of illustration and are not to be construed as limitations, as many variations thereof are possible without departing from the spirit and scope of the invention.

### Example 1-4

These examples illustrate nutritional embodiments of the present disclosure, the ingredients of which are listed in the following table. All ingredient amounts are listed as kg per 1000 kg batch of product, unless otherwise specified. The formulations are shelf stable, aqueous emulsions.

The formulations are prepared by conventional methods by combining the appropriate ingredients into a separate carbohydrate-mineral slurry, a separate protein-in-water slurry, and a separate protein-in-oil slurry. For each individual slurry, the ingredients are mixed together under temperature and shear appropriate for the selected materials, after which the different slurries are combined in an blend tank, subjected to ultra high temperature treatment (UHT) and then homogenized at about 3000 psi. Vitamins, flavors and other heat-sensitive materials are then added to the homogenized mixture. The resulting mixture is diluted with water as needed to achieve the desired concentrations and density (˜1.0628 g/mL). The resulting nutritional emulsion is then sterilized and retort packaged into 8 oz plastic bottles. The selected bottles have narrow neck portions extending from 1-5 cm from the broader package body.

The exemplified compositions when packaged provide desirable features, including one or more desirable features such as physical or chemical or emulsion stability, desirable hedonics, favorable rheology or viscoelastic properties, and product performance as defined herein. The formulations are physically stable when packaged and stored for up to 18 months at 20° C. and provide a blunted glycemic response with minimal or no gastrointestinal intolerance, especially when used in diabetics or other individuals in whom such a blunted glycemic response would be beneficial.

| Ingredient | Example 1 | Example 2 | Example 3 | Example 4 |
|---|---|---|---|---|
| Water | QS | QS | QS | QS |
| Fibersol-2 ™¹ | 52.6 | 68.6 | 137.2 | 205.7 |
| Milk protein concentrate | 38.5 | 38.5 | 38.5 | 38.5 |
| Sucromalt² | 36.4 | 36.4 | 36.4 | 36.4 |
| Glycerine | 22.0 | 22.0 | 22.0 | 22.0 |
| Enova ™ Oil³ | 18.6 | 18.6 | 18.6 | 18.6 |
| Soy protein concentrate | 18 | 18 | 18 | 18 |
| MALTRIN ® M 100⁴ | 10.6 | 10.6 | 10.6 | 10.6 |
| Canola oil | 7.8 | 7.8 | 7.8 | 7.8 |
| Fructooligosaccharide | 5.0 | 6.5 | 13.0 | 19.6 |
| Plant sterol esters | 3.2 | 3.2 | 3.2 | 3.2 |
| High Oleic Safflower Oil | 3.1 | 3.1 | 3.1 | 3.1 |
| Magnesium Phosphate | 2.4 | 2.4 | 2.4 | 2.4 |
| Flavor | 3.3 | 3.3 | 3.3 | 3.3 |
| Potassium citrate | 2.0 | 2.0 | 2.0 | 2.0 |
| Sodium citrate | 2.0 | 2.0 | 2.0 | 2.0 |
| Soy lecithin (5% OB) in | 1.6 | 1.6 | 1.6 | 1.6 |
| Soybean oil | | | | |
| Potassium Chloride | 0.900 | 0.900 | 0.900 | 0.900 |
| Calcium Phosphate | 0.670 | 0.670 | 0.670 | 0.670 |
| Choline Chloride | 0.6515 | 0.6515 | 0.6515 | 0.6515 |
| Sodium Chloride | 0.650 | 0.650 | 0.650 | 0.650 |
| Ascorbic Acid | 0.5841 | 0.5841 | 0.5841 | 0.5841 |
| Magnesium Chloride | 0.5000 | 0.5000 | 0.5000 | 0.5000 |
| Viscarin SA-359⁵ | 0.4500 | 0.4500 | 0.4500 | 0.4500 |
| 45% KOH Solution | 0.4181 | 0.4181 | 0.4181 | 0.4181 |
| UTM/TM/WSV | 0.2717 | 0.2717 | 0.2717 | 0.2717 |
| Liquid Sucrolose (25%) | 0.1600 | 0.1600 | 0.1600 | 0.1600 |
| Acesulfame Potassium | 0.0940 | 0.0940 | 0.0940 | 0.0940 |
| Turmeric concentrate | 0.0750 | 0.0750 | 0.0750 | 0.0750 |
| Vitamin DEK premix | 0.0651 | 0.0651 | 0.0651 | 0.0651 |
| Vit. A Palm. (54% oil) | 0.0091 | 0.0091 | 0.0091 | 0.0091 |
| Potassium iodide | 220 mg | 220 mg | 220 mg | 220 mg |
| Vitamin B12 | 16 mg | 16 mg | 16 mg | 16 mg |
| (Total Fiber) | 2.3% | 3.0% | 6.0% | 9.0% |

¹Soluble fiber source; 37% by weight of dietary fiber; ADM Company, Decatur, Illinois USA
²Sucromalt SM05 Syrup with 37% fructose, 13% leucrose (dry wt); Cargill, Minneapolis, MN USA
³Diacylglycerol oil; Kao Health and Nutrition, Itasca, IL USA
⁴Maltodextrin DE 9-12; Grain Processing Corporation, Muscatine Iowa
⁵Carrageenan: FMC Biopolymer, Philadelphia, Pennsylvania, USA

### Examples 5-8

These examples illustrate nutritional embodiments of the present disclosure, the ingredients of which are listed in the following table. All ingredient amounts are listed as kg per 1000 kg batch of product, unless otherwise specified. The formulations are shelf stable, aqueous emulsions that are prepared and packaged in accordance with the process described in Examples 1-4.

| Ingredient | Example 5 | Example 6 | Example 7 | Example 8 |
|---|---|---|---|---|
| Water | QS | QS | QS | QS |
| Fibersol 2 | 52.6 | 52.6 | 52.6 | 52.6 |
| Milk protein concentrate | 38.5 | 38.5 | 38.5 | 38.5 |
| Sucromalt | 36.4 | 36.4 | 36.4 | 36.4 |
| Glycerin | 22.0 | 22.0 | 22.0 | 22.0 |
| Enova ™ Oil | 20.0 | 25.0 | 30.0 | 40.0 |
| Soy protein concentrate | 18 | 18 | 18 | 18 |
| Maltrin M 100 | 10.6 | 10.6 | 10.6 | 10.6 |
| Canola oil | 7.8 | 7.8 | 7.8 | 7.8 |
| Fructooligosaccharide | 5.0 | 5.0 | 5.0 | 5.0 |
| Plant sterol esters | 3.2 | 3.2 | 3.2 | 3.2 |
| High Oleic Safflower Oil | 3.1 | 3.1 | 3.1 | 3.1 |
| Magnesium Phosphate | 2.4 | 2.4 | 2.4 | 2.4 |
| Flavor | 3.3 | 3.3 | 3.3 | 3.3 |
| Potassium citrate | 2.0 | 2.0 | 2.0 | 2.0 |
| Sodium citrate | 2.0 | 2.0 | 2.0 | 2.0 |
| Soy lecithin (5% OB) in | 1.6 | 1.6 | 1.6 | 1.6 |
| Soybean oil | | | | |
| Potassium Chloride | 0.900 | 0.900 | 0.900 | 0.900 |
| Calcium Phosphate | 0.670 | 0.670 | 0.670 | 0.670 |
| Choline Chloride | 0.6515 | 0.6515 | 0.6515 | 0.6515 |
| Sodium Chloride | 0.650 | 0.650 | 0.650 | 0.650 |
| Ascorbic Acid | 0.5841 | 0.5841 | 0.5841 | 0.5841 |
| Magnesium Chloride | 0.5000 | 0.5000 | 0.5000 | 0.5000 |
| Viscarin SA-359 | 0.4500 | 0.4500 | 0.4500 | 0.4500 |
| 45% KOH Solution | 0.4181 | 0.4181 | 0.4181 | 0.4181 |
| UTM/TM/WSV | 0.2717 | 0.2717 | 0.2717 | 0.2717 |
| Liquid Sucralose (25%) | 0.1600 | 0.1600 | 0.1600 | 0.1600 |
| Acesulfame Potassium | 0.0940 | 0.0940 | 0.0940 | 0.0940 |
| Turmeric concentrate | 0.0750 | 0.0750 | 0.0750 | 0.0750 |
| Vitamin DEK premix | 0.0651 | 0.0651 | 0.0651 | 0.0651 |
| Vit. A Palm. (54% oil) | 0.0091 | 0.0091 | 0.0091 | 0.0091 |
| Potassium iodide | 220 mg | 220 mg | 220 mg | 220 mg |
| Vitamin B12 | 16 mg | 16 mg | 16 mg | 16 mg |
| (Total Fiber) | 2.3% | 2.3% | 2.3% | 2.3% |

### Examples 9-12

These examples illustrate nutritional embodiments of the present disclosure, the ingredients of which are listed in the following table. All ingredient amounts are listed as kg per 1000 kg batch of product, unless otherwise specified. The formulations are shelf stable, aqueous emulsions that are prepared and packaged in accordance with the process described in Examples 1-4.

| | | Example | Example | Example |
|---|---|---|---|---|
| Ingredient | Example 9 | 10 | 11 | 12 |
| Water | QS | QS | QS | QS |
| Fibersol 2 | 52.6 | 52.6 | 52.6 | 52.6 |
| Milk protein concentrate | 10 | 30 | 60 | 90 |
| Sucromalt | 36.4 | 36.4 | 36.4 | 36.4 |
| Glycerin | 22.0 | 22.0 | 22.0 | 22.0 |
| Enova ™ Oil | 18.6 | 18.6 | 18.6 | 18.6 |
| Soy protein concentrate | 18 | 18 | 18 | 18 |
| Maltrin M 100 | 10.6 | 10.6 | 10.6 | 10.6 |
| Canola oil | 7.8 | 7.8 | 7.8 | 7.8 |
| Fructooligosaccharide | 5.0 | 5.0 | 5.0 | 5.0 |
| Plant sterol esters | 3.2 | 3.2 | 3.2 | 3.2 |
| High Oleic Safflower Oil | 3.1 | 3.1 | 3.1 | 3.1 |
| Magnesium Phosphate | 2.4 | 2.4 | 2.4 | 2.4 |
| Flavor | 3.3 | 3.3 | 3.3 | 3.3 |
| Potassium citrate | 2.0 | 2.0 | 2.0 | 2.0 |
| Sodium citrate | 2.0 | 2.0 | 2.0 | 2.0 |
| Soy lecithin (5% OB) in | 1.6 | 1.6 | 1.6 | 1.6 |
| Soybean oil | | | | |
| Potassium Chloride | 0.900 | 0.900 | 0.900 | 0.900 |
| Calcium Phosphate | 0.670 | 0.670 | 0.670 | 0.670 |
| Choline Chloride | 0.6515 | 0.6515 | 0.6515 | 0.6515 |
| Sodium Chloride | 0.650 | 0.650 | 0.650 | 0.650 |
| Ascorbic Acid | 0.5841 | 0.5841 | 0.5841 | 0.5841 |
| Magnesium Chloride | 0.5000 | 0.5000 | 0.5000 | 0.5000 |
| Viscarin SA-359 | 0.4500 | 0.4500 | 0.4500 | 0.4500 |
| 45% KOH Solution | 0.4181 | 0.4181 | 0.4181 | 0.4181 |
| UTM/TM/WSV | 0.2717 | 0.2717 | 0.2717 | 0.2717 |
| Liquid Sucralose (25%) | 0.1600 | 0.1600 | 0.1600 | 0.1600 |
| Acesulfame Potassium | 0.0940 | 0.0940 | 0.0940 | 0.0940 |
| Turmeric concentrate | 0.0750 | 0.0750 | 0.0750 | 0.0750 |
| Vitamin DEK premix | 0.0651 | 0.0651 | 0.0651 | 0.0651 |
| Vit. A Palm. (54% oil) | 0.0091 | 0.0091 | 0.0091 | 0.0091 |
| Potassium iodide | 220 mg | 220 mg | 220 mg | 220 mg |
| Vitamin B12 | 16 mg | 16 mg | 16 mg | 16 mg |
| (Total Fiber) | 2.3% | 2.3 | 2.3 | 2.3 |

### Examples 13-16

These examples illustrate nutritional embodiments of the present disclosure, the ingredients of which are listed in the following table. All ingredient amounts are listed as kg per 1000 kg batch of product, unless otherwise specified. The formulations are shelf stable, aqueous emulsions that are prepared and packaged in accordance with the process described in Examples 1-4.

| | Example | Example | Example | Example |
|---|---|---|---|---|
| Ingredient | 13 | 14 | 15 | 16 |
| Water | QS | QS | QS | QS |
| Fibersol 2 | 52.6 | 52.6 | 52.6 | 52.6 |
| Milk protein concentrate | 38.5 | 38.5 | 38.5 | 38.5 |
| Sucromalt | 36.4 | 36.4 | 36.4 | 36.4 |
| Glycerin | 25.0 | 30.0 | 35.0 | 40.0 |
| Enova ™ Oil | 18.6 | 18.6 | 18.6 | 18.6 |
| Soy protein concentrate | 18 | 18 | 18 | 18 |
| Maltrin M 100 | 10.6 | 10.6 | 10.6 | 10.6 |
| Canola oil | 7.8 | 7.8 | 7.8 | 7.8 |
| Fructooligosaccharide | 5.0 | 5.0 | 5.0 | 5.0 |
| Plant sterol esters | 3.2 | 3.2 | 3.2 | 3.2 |
| High Oleic Safflower Oil | 3.1 | 3.1 | 3.1 | 3.1 |
| Magnesium Phosphate | 2.4 | 2.4 | 2.4 | 2.4 |
| Flavor | 3.3 | 3.3 | 3.3 | 3.3 |
| Potassium citrate | 2.0 | 2.0 | 2.0 | 2.0 |
| Sodium citrate | 2.0 | 2.0 | 2.0 | 2.0 |
| Soy lecithin (5% OB) in | 1.6 | 1.6 | 1.6 | 1.6 |
| Soybean oil | | | | |
| Potassium Chloride | 0.900 | 0.900 | 0.900 | 0.900 |
| Calcium Phosphate | 0.670 | 0.670 | 0.670 | 0.670 |
| Choline Chloride | 0.6515 | 0.6515 | 0.6515 | 0.6515 |
| Sodium Chloride | 0.650 | 0.650 | 0.650 | 0.650 |
| Ascorbic Acid | 0.5841 | 0.5841 | 0.5841 | 0.5841 |
| Magnesium Chloride | 0.5000 | 0.5000 | 0.5000 | 0.5000 |
| Viscarin SA-359 | 0.4500 | 0.4500 | 0.4500 | 0.4500 |
| 45% KOH Solution | 0.4181 | 0.4181 | 0.4181 | 0.4181 |
| UTM/TM/WSV | 0.2717 | 0.2717 | 0.2717 | 0.2717 |
| Liquid Sucralose (25%) | 0.1600 | 0.1600 | 0.1600 | 0.1600 |
| Acesulfame Potassium | 0.0940 | 0.0940 | 0.0940 | 0.0940 |
| Turmeric concentrate | 0.0750 | 0.0750 | 0.0750 | 0.0750 |
| Vitamin DEK premix | 0.0651 | | 0.0651 | 0.0651 |
| Vit. A Palm. (54% oil) | 0.0091 | 0.0091 | 0.0091 | 0.0091 |
| Potassium iodide | 220 mg | 220 mg | 220 mg | 220 mg |
| Vitamin B12 | 16 mg | 16 mg | 16 mg | 16 mg |
| Total Fiber | 2.3% | 2.3 | 2.3 | 2.3 |

### Examples 17-20

These examples illustrate nutritional embodiments of the present disclosure, the ingredients of which are listed in the following table. All ingredient amounts are listed as kg per 1000 kg batch of product, unless otherwise specified. The formulations are shelf stable, aqueous emulsions that are prepared and packaged in accordance with the process described in Examples 1-4.

| | Example | Example | Example | Example |
|---|---|---|---|---|
| Ingredient | 17 | 18 | 19 | 20 |
| Water | QS | QS | QS | QS |
| Fibersol 2 | 52.6 | 52.6 | 52.6 | 52.6 |
| Milk protein concentrate | 38.5 | 38.5 | 38.5 | 38.5 |
| Sucromalt | 30 | 35 | 40 | 50 |
| Glycerin | 22.0 | 22.0 | 22.0 | 22.0 |
| Enova ™ Oil | 18.6 | 18.6 | 18.6 | 18.6 |
| Soy protein concentrate | 18 | 18 | 18 | 18 |
| Maltrin M 100 | 10.6 | 10.6 | 10.6 | 10.6 |
| Canola oil | 7.8 | 7.8 | 7.8 | 7.8 |
| Fructooligosaccharide | 5.0 | 5.0 | 5.0 | 5.0 |
| Plant sterol esters | 3.2 | 3.2 | 3.2 | 3.2 |
| High Oleic Safflower Oil | 3.1 | 3.1 | 3.1 | 3.1 |
| Magnesium Phosphate | 2.4 | 2.4 | 2.4 | 2.4 |
| Flavor | 3.3 | 3.3 | 3.3 | 3.3 |
| Potassium citrate | 2.0 | 2.0 | 2.0 | 2.0 |
| Sodium citrate | 2.0 | 2.0 | 2.0 | 2.0 |
| Soy lecithin (5% OB) in | 1.6 | 1.6 | 1.6 | 1.6 |
| Soybean oil | | | | |
| Potassium Chloride | 0.900 | 0.900 | 0.900 | 0.900 |
| Calcium Phosphate | 0.670 | 0.670 | 0.670 | 0.670 |
| Choline Chloride | 0.65 5 | 0.6515 | 0.6515 | 0.6515 |
| Sodium Chloride | 0.650 | 0.650 | 0.650 | 0.650 |
| Ascorbic Acid | 0.5841 | 0.5841 | 0.5841 | 0.5841 |
| Magnesium Chloride | 0.5000 | 0.5000 | 0.5000 | 0.5000 |
| Viscarin SA-359 | 0.4500 | 0.4500 | 0.4500 | 0.4500 |
| 45% KOH Solution | 0.4181 | 0.4181 | 0.4181 | 0.4181 |
| UTM/TM/WSV | 0.2717 | 0.2717 | 0.2717 | 0.2717 |
| Liquid Sucralose (25%) | 0.1600 | 0.1600 | 0.1600 | 0.1600 |
| Acesulfame Potassium | 0.0940 | 0.0940 | 0.0940 | 0.0940 |
| Turmeric concentrate | 0.0750 | 0.0750 | 0.0750 | 0.0750 |
| Vitamin DEK premix | 0.0651 | 0.0651 | 0.0651 | 0.0651 |
| Vit. A Palm. (54% oil) | 0.0091 | 0.0091 | 0.0091 | 0.0091 |
| Potassium iodide | 220 mg | 220 mg | 220 mg | 220 mg |
| Vitamin B12 | 16 mg | 16 mg | 16 mg | 16 mg |
| Total Fiber | 2.3% | 2.3% | 2.3% | 2.3% |

### Study I

In this study, an embodiment of the present invention (A1) is evaluated for insulin sensitivity benefits relative to separate controls (A2 and A3). A1 is a balanced nutritional formulation of the present invention and is compared to formulations A2 (Carb-Chromium) and A3 (carb-protein-chromium) which contain only selected components of A1 and do not contain the requisite balanced formulation required of the present invention.

| | Formula A1 | Formula A2 | Formula A3 |
|---|---|---|---|
| Ingredient | g/100 g diet | g/100 g diet | g/100 g diet |
| Protein (milk protein conc., | 5.5 | — | 5.4 |
| soy protein conc.) | | | |
| Carbohydrate blend | 12.7 | 11.1 | 11.1 |
| (sucromalt, glycerol, | | | |
| Fibersol II) with total fiber | | | |
| of ~2.6-5.2 | | | |
| Chromium picolinate | 0.7 mg/100 g | 0.7 mg/100 g | 0.7 mg/100 g |
| DAG Oil | 0.197 | | |
| Canola oil | 0.82 | | |
| Ascorbic acid | 0.028 | | |
| Maltrin M100 | 1.059 | | |
| Mg Chloride | 0.075 | | |
| Sodium Chloride | 0.05 | | |
| Potassium chloride | 0.09 | | |
| Potassium citrate | 0.2 | | |
| Potassium hydroxide 45% | 0.041 | | |
| Sodium citrate | 0.2 | | |
| Choline chloride | 0.065 | | |
| Tricalcium phosphate | 0.1 | | |
| Mg Phosphate dibasic | 0.25 | | |
| High oleic safflower oil | 0.329 | | |
| Carrageenan Viscarin SA 359 | 0.04 | | |
| Vitamin D, E, K | 0.006 | | |
| FOS powder | 0.5 | | |
| UTM/TM/WSV Premix | 0.027 | | |
| Fluid Lecithin | 0.164 | | |
| Caloric density | 0.837 | 0.3121 | 0.5 |

In preparation for this example, 32 male Zucker fa/fa rats (9 wks, 5 days old), 0.423 kg body weights at the start of the study) are sorted into three groups (n=10-11) matched for body weight. The rats are given ad libitum access to a semi-purified pelleted diet (“Study Diet”) meant to mimic a poor-quality Standard American Diet, in that it is rich in saturated fat and high glycemic carbohydrates. In addition, the rats are given access to one of the three liquid supplements A1, A2, or A3. A1 is a balanced nutritional embodiment of the present invention. A2 is a solution comprising the functional carbohydrates and chromium picolinate of A1. A3 is a solution comprising the functional carbohydrates, chromium and proteins of A1. Both of the A2 and A3 solutions are prepared so the rats consume the levels of functional carbohydrates (Fibersol, Sucromalt and Glycerol) (2.83 kcals/gram) and proteins (milk protein concentrate and soy protein concentrate) (3.46 kcals/gram) found in the A1 formulation.

Overnight fasting blood samples are taken for assay of glucose, insulin glycated hemoglobin after 0, 14, and 28 days of feeding the Study Diet with or without supplementation. Insulin tolerance is measured just before rats are given study diets and after 28 days of feeding. To measure insulin tolerance, overnight fasted rats are injected with regular insulin (1 U/kg body wt; Humulin®, Eli Lilly Company). Blood samples are obtained from the tip of the tail before and at 30, 60, 90, and 120 minutes after insulin injection. Food is returned at the end of the test.

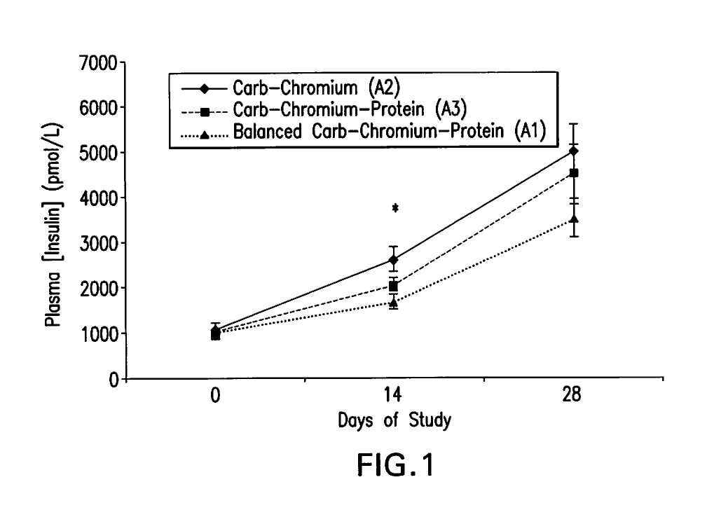

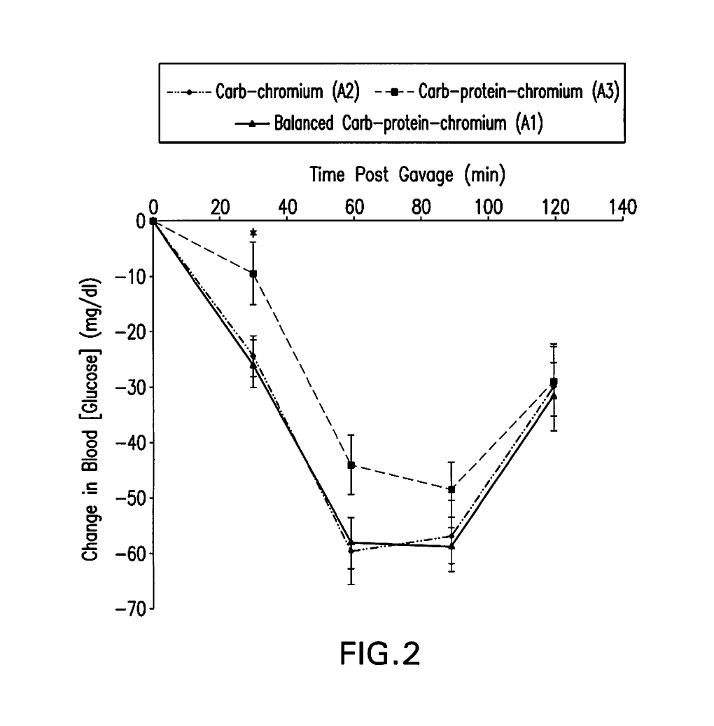

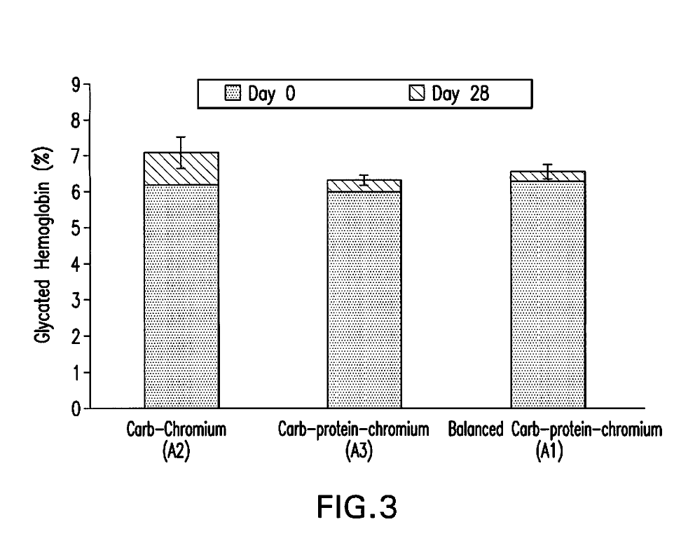

Supplement compositions do not affect fasting blood glucose concentration over the 28 day feeding period. Surprisingly, A3 and A2 increase plasma insulin compared to A1 (see FIG. 1; p<0.01 on day 14 for A2 vs. A1). A3 significantly worsens insulin sensitivity compared to A1 (see FIG. 2). A2 supplementation magnifies the increase in glycated hemoglobin 0.9% from Day 0 to Day 28 compared to 0.2% for A1 (FIG. 3).

Based on the above assessment, it is surprisingly found that voluntary consumption of the presumed functional ingredients of the A1 formulation (Fibersol, Sucromalt, glycerol, chromium picolinate, milk protein concentrate, and soy protein concentrate) worsens insulin sensitivity and metabolic control compared to voluntary consumption of the complete A1 formula. Thus, the beneficial effect of the A1 formula cannot be explained by any individual component and must reside in the complete balanced formulation as disclosed herein.

### Study II

A study is conducted in which an embodiment of the present invention is evaluated for insulin sensitivity and glycated hemoglobin.

In preparation for the study, twenty male Zucker fa/fa rats (9 wks old, 0.36 kg body weight at the start of the study) are sorted into two groups of 10 matched for body weight. The rats are fed “Study Diet”, a semi-purified pelleted diet meant to mimic a poor-quality Standard American Diet, in that it is rich in saturated fat and high glycemic carbohydrates, including sucrose and maltodextrin. The rats are either fed the Study Diet alone (“No Supplement”) or are supplemented with Formula A1 described earlier.

Overnight fasted blood samples are taken for assay of glucose, insulin glycated hemoglobin after 0, 14, and 28 days of feeding Study Diet with or without supplementation. Insulin tolerance is measured just before rats are given study diets and after 14 days of feeding. Rats are fasted overnight 16 hr and a fasting blood sample is collected from the tip of the tail at zero time. Immediately afterwards, rats are injected with regular insulin (1 U/kg body wt; Humulin®, Eli Lilly Company). Blood samples are obtained from the tip of the tail at 30, 60, 90, and 120 minutes after insulin injection. Food is returned at the end of the test.

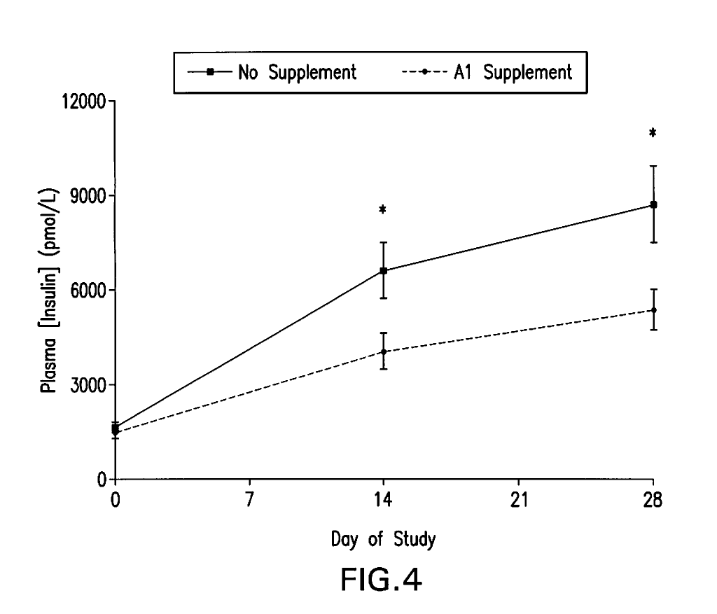

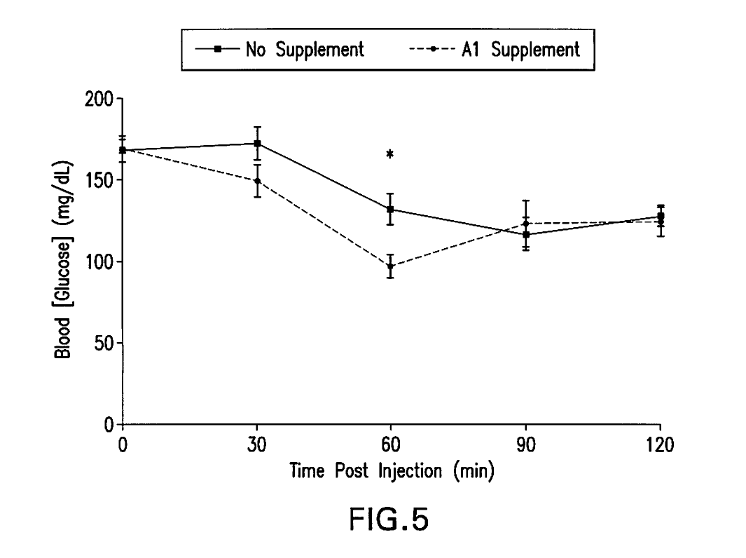

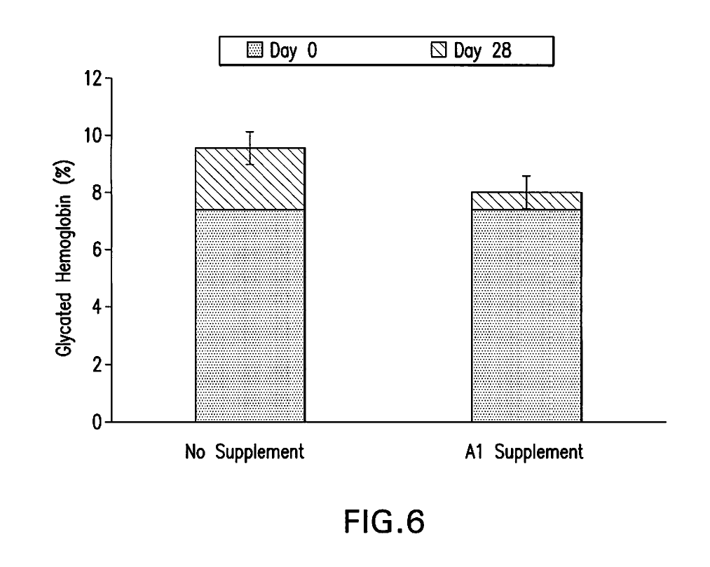

Supplementation with the A1 formulation does not affect blood glucose concentrations. Surprisingly, voluntary consumption of A1 reduced plasma insulin concentration (see FIG. 4) and improved insulin tolerance (see FIG. 5). Glycated hemoglobin concentration increases by 2.1% over the duration of the study (FIG. 6), but surprisingly, voluntary consumption of Viking 2 for only four weeks limits the increase to only 0.6%. The rats in these experiments are not forced to consume Viking 2. They are merely given access to the formula in addition to their highly palatable diet rich in fat and sugar. Surprisingly, these pre-diabetic rats voluntarily consume enough of the A1 formulation to improve their insulin sensitivity as measured by plasma insulin concentration and insulin tolerance test. In addition, it is surprising that voluntary consumption of the A1 formulation for only four weeks can sharply limit the rise in glycated hemoglobin induced by high fat, high sucrose Study Diet in these prediabetic rats.

### Study III

A study is conducted in which an embodiment of the present invention is evaluated for satiety effects.

In preparation for the study, forty male Zucker fa/fa rats (9 wks old, 0.36 kg body weight at the start of the study) are sorted into four groups of 10. The groups are matched for body weight. The rats are fed one of two solid diets. The first is a control chow Harlan 2018 (Harlan-Teklad, Madison, Wis.) and the second is a “Study Diet” which is a semi-purified pelleted diet meant to mimic a poor-quality Standard American Diet, in that it is rich in saturated fat and high glycemic carbohydrates, including sucrose and maltodextrin. The rats are either fed the unsupplemented solid diets (either control chow or the Study Diet alone or those same solid diets are supplemented with Formula A1 (liquid) described earlier.

Experimental diets are provided for 28 days. Solid pelleted diets are fed by giving the rats approximately 50 grams of food on top of wire cage lid and weighing what remained daily. Spillage is taken into account. Liquid diet (A1 formula) is fed by attaching a bottle to the front of the cage. Consumption is measured by weighing the bottles. Old diet is discarded and clean bottles and fresh liquid and solid diet are provided da9ily. All rats are fed solid and liquid diets ad libitum.

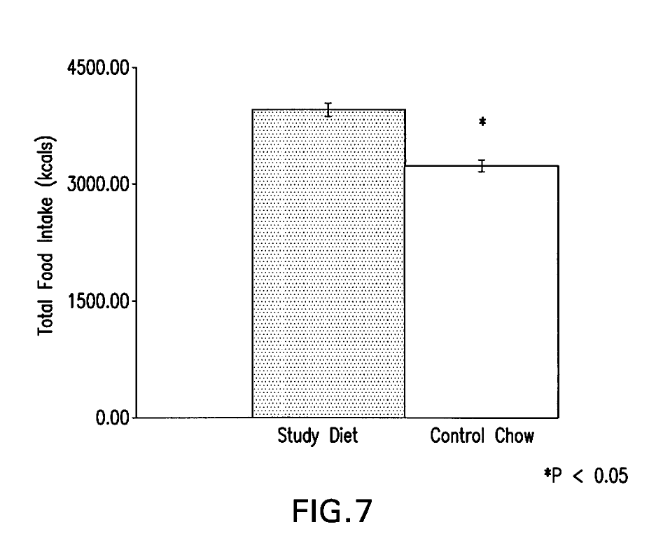

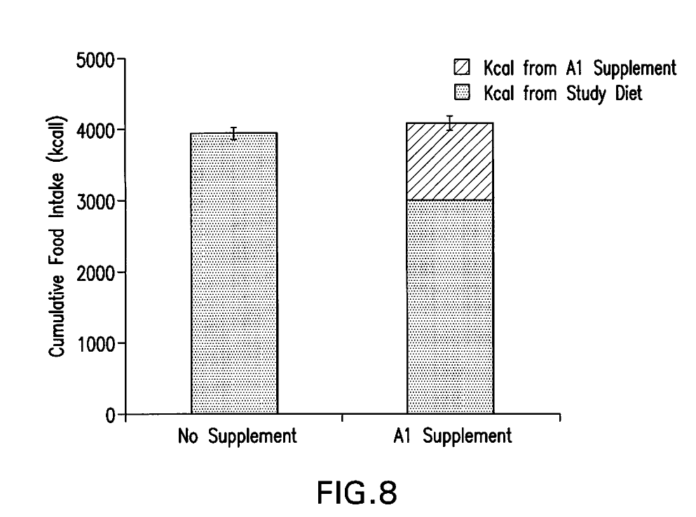

As expected, the study diet increased food intake and body weight compared to control chow (p<0.05, see FIG. 7). This shows that the high fat, high sucrose study diet is preferred compared to the regular chow diet, suggesting that the rats found it highly palatable. When offered access to the A1 formulation, however, rats voluntarily consumed about 1000 kcal over the course of the study. Surprisingly, rats chose to decrease consumption of the palatable, preferred study diet to compensate for the calories they consumed as A1 formulation (p<0.05; see FIG. 8). This suggests that the A1 formulation is surprisingly palatable and satiating, causing rats to reduce intake of a preferred solid diet.

What is claimed is:

1. An aqueous emulsion comprising fat, protein, and carbohydrate, which includes from 1.75% to about 4.0% by weight of diacylglycerol oil and from about 1.5% to about 9.0% by weight of fiber, wherein the aqueous emulsion has a viscosity of less than about 300 centipoise at 20° C.

2. The aqueous emulsion of claim 1 wherein the emulsion comprises from about 5% to about 40% by weight of the carbohydrate, from about 2% to about 30% by weight of fat, and from about 1% to about 15% by weight of protein.

3. The aqueous emulsion of claim 2 wherein the emulsion comprises from about 2.5% to about 6% of fiber by weight of the emulsion.

4. The aqueous emulsion of claim 2 wherein the fiber represents from about 12% to about 40% by weight of the carbohydrates in the emulsion.

5. The aqueous emulsion of claim 2 wherein the fiber includes a fructooligosaccharide which represents from about 5% to about 50% by weight of fiber in the emulsion.

6. The aqueous emulsion of claim 2 wherein the emulsion comprises from about 1.8% to about 3% of diacylglycerol oil by weight of the emulsion.

7. The aqueous emulsion of claim 2 wherein the diacylglycerol oil represents from about 40% to about 80% by weight of total fat in the emulsion.

8. The aqueous emulsion of claim 2 wherein the emulsion has a weight ratio of fiber to diacylglycerol oil of from about 1.20:1 to about 5:1.

9. The aqueous emulsion of claim 2 wherein the composition has a viscosity of from about 10 cps to about 160 cps at 20° C.

10. The aqueous emulsion of claim 2 further comprising from about 0.1% to about 0.5% by weight of lecithin.

11. The aqueous emulsion of claim 2 further comprising a package within which the emulsion is contained, wherein the package has an interior plastic surface area in contact with the emulsion and which interior plastic surface area represents a majority of the interior surface.

12. The aqueous emulsion of claim 11 wherein the emulsion and package are retort sterilized.

13. An aqueous emulsion comprising fat, protein, and carbohydrate, which includes from 1% to about 4.0% of diacylglycerol oil by weight of the aqueous emulsion and from about 2.0% to about 9.0% of fiber by weight of the aqueous emulsion, wherein the aqueous emulsion has a viscosity of less than about 300 centipoise at 20° C.

14. The aqueous emulsion of claim 13 wherein the emulsion comprises from about 5% to about 40% by weight of the carbohydrate, from about 2% to about 30% by weight of fat, and from about 1% to about 15% by weight of protein.

15. The aqueous emulsion of claim 14 wherein the emulsion comprises from about 2.2% to about 6% of fiber by weight of the emulsion.

16. The aqueous emulsion of claim 14 wherein the fiber represents from about 12% to about 40% by weight of the carbohydrates in the emulsion.

17. The aqueous emulsion of claim 14 wherein the fiber includes a fructooligosaccharide which represents from about 5% to about 50% by weight of fiber in the emulsion.

18. The aqueous emulsion of claim 14 wherein the emulsion comprises from about 1.8% to about 3% of diacylglycerol oil by weight of the emulsion.

19. The aqueous emulsion of claim 14 wherein the diacylglycerol oil represents from about 40% to about 80% by weight of total fat in the emulsion.

20. The aqueous emulsion of claim 14 wherein the emulsion has a weight ratio of fiber to diacylglycerol oil of from about 1.20:1 to about 5:1.

21. The aqueous emulsion of claim 14 wherein the composition has a viscosity of from about 10 cps to about 160 cps at 20° C.

22. The aqueous emulsion of claim 14 further comprising from about 0.1% to about 0.5% by weight of lecithin.

23. The aqueous emulsion of claim 14 further comprising a package within which the emulsion is contained, wherein the package has an interior plastic surface area in contact with the emulsion and which interior plastic surface area represents a majority of the interior surface.

24. The aqueous emulsion of claim 23 wherein the emulsion and package are retort sterilized.
